(19) United States
(12) Patent Application Publication
(10) Pub. No.: US 2009/0128713 A1
(43) Pub. Date: May 21, 2009

(54) DIGITAL BROADCAST RECEIVER AND CHANNEL SWITCHING METHOD THEREOF

(75) Inventor: Seong Geun KWON, Daegu Metropolitan City (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/273,347

(22) Filed: Nov. 18, 2008

(30) Foreign Application Priority Data
Nov. 20, 2007 (KR) 10-2007-0118490

(51) Int. Cl. H04N 5/50

(52) U.S. Cl. 348/731; 348/E05.097

(57) ABSTRACT

A digital broadcast receiver and channel switching method are provided for minimizing channel switching latency by skipping an unnecessary PMT update and PIDs reset processes. A channel switching method for a digital broadcast receiver detects a channel-switching command for switching to a service channel, checks a first version of information of a currently received program mapping table received on the service channel upon detecting the channel-switching command, compares the first version of information with a second version of information of an previously received and stored program mapping table, configures the digital broadcast receiver with a set of packet identifiers (PIDs) associated with the service channel according to a version information comparison result, and performs channel switching to the service channel using the set of PIDs.

### PRIORITY

This application claims the benefit under 35 U.S.C. §119(a) of a Korean patent application filed in the Korean Intellectual Property Office on Nov. 20, 2007 and assigned Serial No. 10-2007-0118490, the entire disclosure of which is hereby incorporated by reference.

### BACKGROUND OF THE INVENTION

1. Field of the Invention

The present invention relates to a digital broadcast system. More particularly, the present invention relates to a digital broadcast receiver and channel switching method for a digital broadcast system that is capable of minimizing channel switching latency.

2. Description of the Related Art

An analog broadcast receiver provides a fast channel switching capability. This is because the channel switching is done simply by tuning the broadcast receiver to the frequency of a modulated broadcast signal and receiving the modulated broadcast signal over the tuned frequency. In the analog receiver, the time taken for the tuning process includes only a channel switching latency factor. However, since the vertical and horizontal synchronization information is frequently supplied, and thus channel switching can be performed quickly, the channel switching latency is effectively ignorable in an analog broadcast receiver.

Recently, with the advent of digital broadcasting, which is advantageous in the utilization of frequency, various types of digital broadcast receivers are emerging in the market. In the digital broadcast system, various broadcast protocols (e.g. Advanced Television Standards Committee (ATSC) protocol) are used. Accordingly, in order to play a digital broadcast stream, a digital broadcast receiver must process various kinds of data formats including Moving Picture Experts Group (MPEG) and other video and audio data compression formats. The processing of the various kinds of formats results in a decoding delay of the digital broadcast receiver, which in turn results in broadcast playback and channel switching latency. In more detail, when switching between channels, the digital broadcast receiver must check Program Specific Information (PSI) and extract Packet Identifiers (PIDs) associated with a target program from the PSI to decode the target program. As part of the process, a decoder waits until the PSI, which is transmitted at a regular interval, is received and the start sequence data is obtained. Accordingly, such operations worsen the channel switching latency, thereby making it difficult to provide an uninterrupted broadcasting service, resulting in user inconvenience. Moreover, in a broadcast receiver which is required to obtain the PSI from a transport stream immediately after detecting a channel switching command, the problem can be worsened.

Accordingly, there is a need for an apparatus and a technique to minimize the channel switching latency.

### SUMMARY OF THE INVENTION

An aspect of the present invention is to address at least the above-mentioned problems and/or disadvantages and to provide at least the advantages described below. Accordingly, an aspect of the present invention is to provide a digital broadcast receiver and channel switching method that is capable of minimizing channel switching latency.

In accordance with an aspect of the present invention, a channel switching method for a digital broadcast receiver is provided. The method includes detecting a channel-switching command for switching to a service channel, checking a first version of information of a currently received program mapping table received on the service channel upon detecting the channel-switching command, comparing the first version of information with a second version of information of a previously received and stored program mapping table, configuring the digital broadcast receiver with a set of packet identifiers (PIDs) associated with the service channel according to a version information comparison result and performing channel switching to the service channel using the set of PIDs.

In accordance with another aspect of the present invention, a channel switching method for a digital broadcast receiver is provided. The method includes detecting a channel-switching command for switching to a service channel, extracting a first information from a set of packet identifiers (PIDs) listed in a currently received program mapping table upon detecting the channel-switching command, comparing the first information with a second information extracted from a set of PIDs listed in a previously received program mapping table, configuring a set of PIDs of the digital broadcast receiver according to a result of the comparison between the first information and the second information and performing channel switching to the service channel using the set of PIDs of the digital broadcast receiver.

In accordance with yet another aspect of the present invention, a digital broadcast receiver is provided. The receiver includes an input unit for generating a channel switching command, a tuner for receiving a broadcast signal on a service channel carried by a physical channel in response to the channel switching command, a packet identifier (PID) filter for filtering packets having PIDs associated with the service channel, the PID filter being set with the PIDs and a demodulation controller for controlling update of the PIDs of the PID filter with reference to at least one of version of information of a program mapping table extracted from the broadcast signal and a set of PIDs listed in the program mapping table.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram illustrating a configuration of a digital broadcast receiver according to an exemplary embodiment of the present invention;

FIG. 2 is a block diagram illustrating a configuration of a broadcast reception unit according to an exemplary embodiment of the present invention; and

FIG. 3 is a flowchart illustrating a channel switching method for a digital broadcast receiver according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the detailed description and claims are not limited to the bibliographical meanings, but are merely used by the inventor to enable a clear and consistent understanding of the invention. Accordingly, it should be apparent to those skilled in the art that the following descriptions of the exemplary embodiments of the present invention are provided for illustration only and not for limiting the invention as defined by the appended claims and their equivalents.

Although the channel switching method is described in association with a Digital Video Broadcasting-Handheld (DVB-H) receiver in the following description, the present invention is not limited thereto. For example, the channel switching method of the present invention can be applied to other types of digital broadcast receivers configured based on any digital broadcast standard supporting channel switching with reference to Program Specific Information (PSI).

The digital broadcast receiver can be a dedicated broadcast receiver or a terminal equipped with a digital broadcast reception module such as a cellular phone, a Personal Digital Assistant (PDA), a Smartphone, a Code Division Multiple Access (CDMA) terminal, a Global System for Mobile communications/General Packet Radio System (GSM/GPRS) terminal, an International Mobile Telecommunication 2000 (IMT-2000) communication terminal including Wideband CDMA (WCDMA) and CDMA2000 terminals, and their equivalent devices.

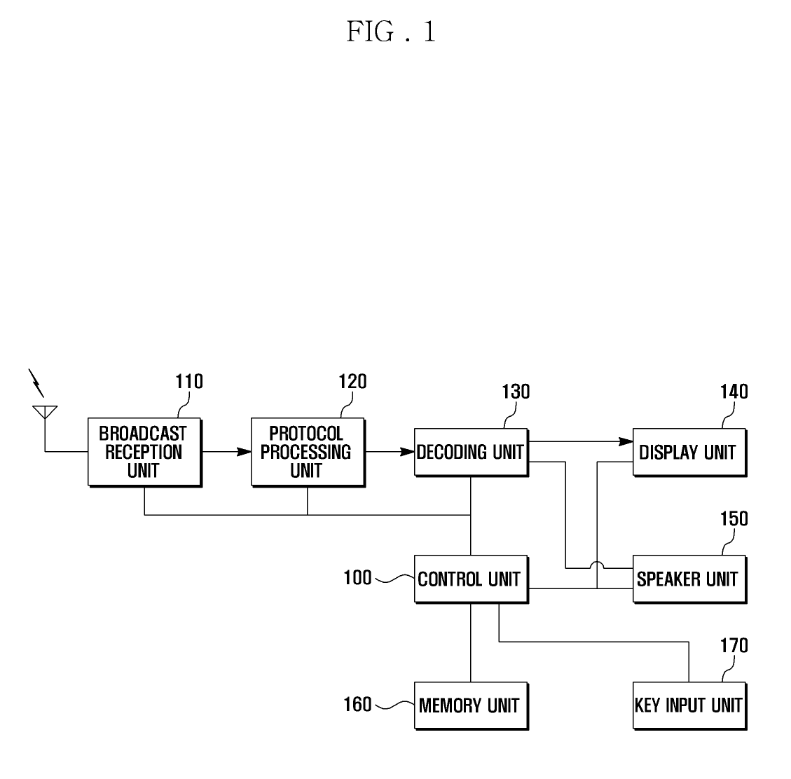

FIG. 1 is a block diagram illustrating a configuration of a digital broadcast receiver according to an exemplary embodiment of the present invention.

Referring to FIG. 1, the digital broadcast receiver includes a control unit 100, a broadcast reception unit 110, a protocol processing unit 120, a decoding unit 130, a display unit 140, a speaker unit 150, a memory unit 160, and a key input unit 170.

The control unit 100 controls general operations of the digital broadcast receiver. The key input unit 170 generates and sends key data to the control unit 100. The key input unit 170 is configured to input user commands for power on/off, menu selection, hot key activation, broadcast program information update, channel switching, and the like. The broadcast program information update can be configured to be initiated with the initialization of the digital broadcast receiver, on a periodic basis, or in response to user's key input. The memory unit 160 can be implemented with a program memory, which stores application programs for executing operations of the digital broadcast receiver, and a data memory for storing application data generated while the application programs run. Particularly, the memory unit 160 may store information associated with a channel switching process of the digital broadcast receiver, e.g. PSI data.

The broadcast reception unit 110 receives broadcast signals on a service channel selected by the user under the control of the control unit 100. The broadcast reception unit 110 extracts PSI from the received broadcast signal and sends the PSI to the control unit 100. The PSI contains a Program Association Table (PAT) and Program Map Tables (PMTs). The PAT contains Packet Identifiers (PIDs) of a plurality of PMTs. The PMT contains PIDs of audio, video, and data streams. When a channel switching command is detected, the broadcast reception unit 110 first determines whether the version of the PMT associated with the target program is changed. If it is determined that the version of the PMT has not changed, the broadcast reception unit 110 executes the channel switching command based on the PMT of the previously stored PSI under the control of the control unit 100. In a case that the version of the PMT has been changed, the broadcast reception unit 110 receives new data on the service channel and executes the channel switching command on the basis of a new version of the PMT contained in the new data. The protocol processing unit 120 performs protocol processing on the service channels and outputs video, audio, and data streams of the target program to the decoding unit 140. The decoding unit 140 is provided with an audio decoder, a video decoder, and a data decoder. The audio decoder decodes the audio stream into audio data and outputs the audio data through the speaker unit 150. The video decoder decodes the video stream into video data and outputs the video data through the display unit 140. The data decoder decodes the data stream into supplementary information data, determines whether the supplementary information data is updated, and performs updating of the supplementary data.

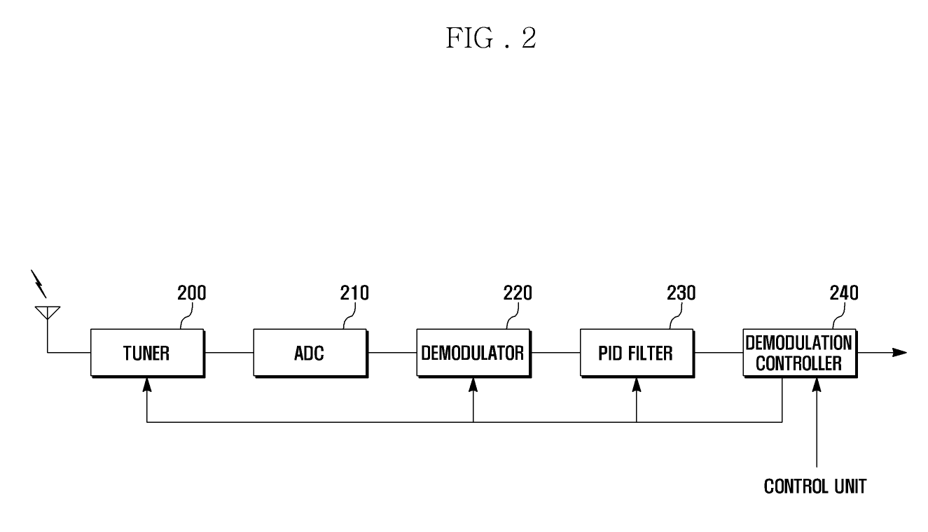

An exemplary structure of a broadcast reception unit is described in more detail with reference to FIG. 2.

FIG. 2 is a block diagram illustrating a configuration of a broadcast reception unit according to an exemplary embodiment of the present invention.

Referring to FIG. 2, the broadcast reception unit includes a tuner 200, an analog/digital converter (ADC) 210, a demodulator 220, a PID filter 230, and a demodulation controller 240.

The demodulation controller 240 controls the tuner 200 to be tuned to a frequency channel of the digital broadcast system and the PID filter 230 to be set with PIDs of video, audio, and data constituting the selected program. At this time, the control unit analyzes Program Specific Information/Service Information (PSI/SI) output by the broadcast reception unit and Session Description Protocol (SDP) information contained in an Electric Service Guide (ESG) and checks the PIDs, Internet Protocol (IP) addresses, and port information associated with service channels. If a service channel is selected by the user, the control unit sends information on the physical channel carrying the selected service channel and PIDs for filtering the program data of the service channel to the demodulation controller 240. When a service channel switching command is input, the demodulation controller 240 compares the version of the PMT contained in the currently received PSI and the version of the PMT contained in the PSI that is previously stored in the memory unit. If the versions of the PMTs of the current PSI and previously stored PSI are identical with each other, the demodulation controller 240 controls such that the channel switching is executed based on the previously stored PSI.

The demodulation controller 240 can be configured such that when the channel switching is requested, it controls to maintain or update a set of PIDs of the PID filter 230 depending on whether the version information of the PMT is received or not. The ADC 210 converts the output signal of the tuner 200 into a modulation signal and outputs the modulation signal to the demodulator 220. The demodulator 220 demodulates the modulation signal into the original broadcast data. The demodulator 220 can be implemented with an Orthogonal Frequency Division Multiplexing (OFDM) or Coded OFDM (COFDM) modulation scheme. The data output by the demodulator 220 includes TS packet streams of MPEG2 Transport Stream (MPEG2-TS), and each TS packet contains a PID for identifying the service channel. The PID filter 230 filters the packets having the PID of the selected service channel from the modulated IP datagrams and sends PSI/SI information to the control unit. The TS data output by the PID filter 230 may contain time slicing information. The demodulation controller 240 controls the receiving of a burst data with reference to the time slicing information. That is, the demodulation controller 240 controls power supplied to the tuner 200 and demodulator 220 using the time slicing information. The time slicing information contains burst-on time information of the selected service channel and buffering service channels. The demodulation controller 240 controls such that the tuner 200 and demodulator 220 power on during the burst-on time and power off at other times.

As described above, the demodulation controller 240 controls the tuner 200 and PID filter 230 according to the channel control data output by the control unit such that the tuner 200 is tuned to the physical channel carrying the service channel selected by the user and the PID filter 230 is set with the PID of the selected service channel. When the channel switching command is received from the control unit, the demodulation controller 240 compares the version of PMT contained in the PSI of the received signal and the version of the PMT contained in the previously stored PSI. When the versions of the currently received PMT and previously stored PMT are identically with each other, the demodulation controller 240 controls such that the channel switching is done without reset of the PIDs of the PID filter 230, resulting in a reduction of PMT update time and thus reducing channel switching latency. Meanwhile, when the currently received PMT and previously stored PMT are different from each other, the demodulation controller 240 may further check the audio, video, and data streams PIDs listed in the PMT. When the PIDs of the audio, video, and data streams of the currently received PMT are identical with those of the previously stored PMT, the demodulation controller 240 determines that there is no change to switch to the selected channel without reset of the PIDs of the PID filter 230.

Until now, the structures and functions of the digital broadcast receiver according to exemplary embodiments of the present invention have been described. An exemplary channel switching method of a digital broadcast receiver is described hereinafter in more detail.

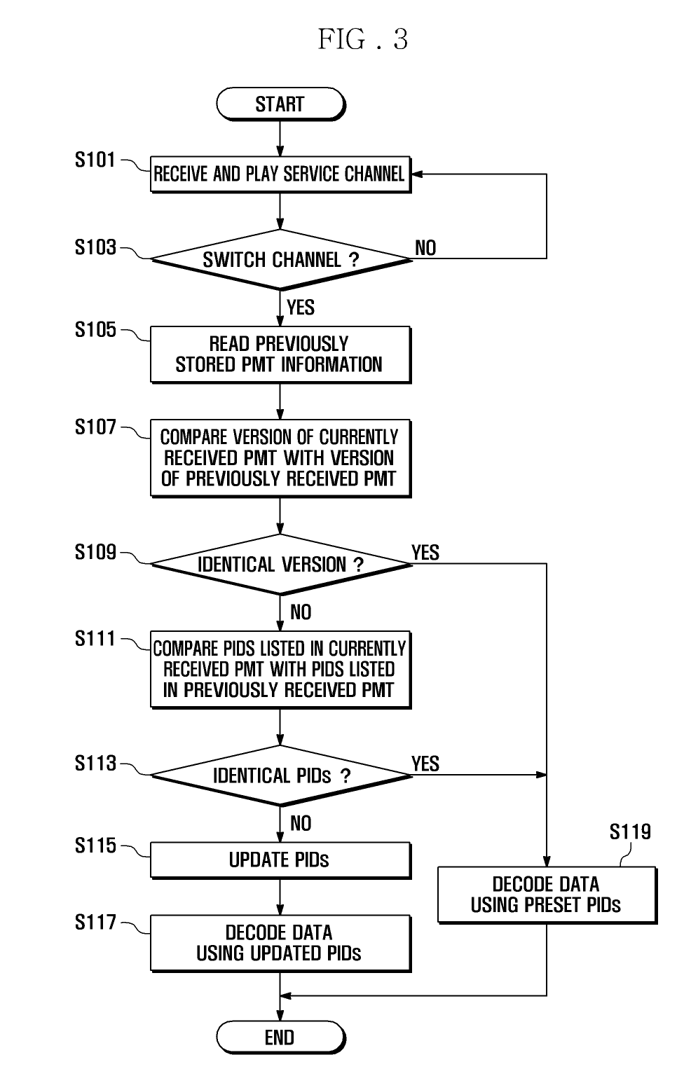

FIG. 3 is a flowchart illustrating a channel switching method for a digital broadcast receiver according to an exemplary embodiment of the present invention. In the following description, the audio, video, and data streams constituting a service channel (or a program) are assigned respective PIDs.

Referring to FIG. 3, in the channel switching method according to an exemplary embodiment of the present invent, the digital broadcast receiver receives broadcast signals broadcasted by a broadcast station and decodes and plays the broadcast data of a specific service channel selected by the user in step S101. While playing the broadcast data of the current service channel, the control unit 100 monitors to detect a channel switching command in step S103. The channel switching command can be generated by pushing a channel switching key on a keypad, a channel switching button touch on a touchscreen, in response to a remote control signal received through a wireless channel and the like.

When a channel switching command is detected, the control unit 100 reads a previously stored PMT in step S105. While receiving broadcast signals, the digital broadcast receiver extracts PSI from the broadcast signals and obtains a PAT and PMTs from the PSI. The PMT lists a plurality of PIDs assigned to respective audio, video, and data streams constituting a program. The PIDs are set in the PID filter 230 under the control of the demodulation controller 240. The audio, video, and data streams constituting the same program may be assigned identical PID. Similarly, the PMTs of the same program have identical version information. The PSI is extracted by the broadcast reception unit 110 and sent to the control unit 100 by the demodulation controller 240. The control unit 100 stores the PSI within the memory unit 160 and obtains the PMT of a program from the PSI. Accordingly, the control unit 100 reads the PMT from the memory unit 160 at step S105.

The control unit 100 compares the versions of the currently received PMT and the previously stored PMT in step S107 and determines whether the version of the currently received PMT is identical with the version the previously stored PMT in step S109. When the version of the currently received PMT is identical with the version of the previously stored PMT, the control unit 100 controls the service channel switching using the preset PIDs in step S119. That is, when the currently received PMT is identical with the previously stored PMT, the control unit 100 performs the service channel switching with the previous PID setting of PID filter 230.

When the version of the currently received PMT differs from the version of the previously stored PMT at step S109, the control unit 100 compares the PIDs listed in the currently received PMT and the PIDs listed in the previously stored PMT in step S111. A reference table listing the PIDs may be stored in the storage unit 160 in order for the control unit 100 to perform the channel switching with reference to the reference table. In an exemplary embodiment, storing the PMT and PID information is performed as a background process regardless of the main operation of the mobile terminal.

Next, the control unit 100 determines whether the PIDs listed in the currently received PMT are identical with the PIDs listed in the previously stored PMT in step S113. When the PIDs listed in the currently received PMT are identical with the PIDs listed in the previously received PMT, the control unit 100 performs the channel switching using the preset PIDs in step S119. Since the PID filter 230 is not unnecessarily reset, the channel switching latency can be reduced.

When it is determined that the PIDs listed in the currently received PMT are not identical with the PIDs listed in the previously stored PMT at step S113, the control unit 100 updates previous PIDs with the PIDs listed in the currently received PMT and performs the channel switching with the updated PIDs in step S115. Next, the control unit 100 decodes and plays the video, audio, and data streams assigned the updated PIDs in step S117. In more detail, when the PIDs listed in the previously stored PMT are not identical with the PIDs listed in the currently received PMT, the control unit 100 updates the PIDs set at the PID filter 230 with the PIDs listed in the currently received PMT. At this time, the control unit 100 controls the demodulation controller 240 to set the tuner with the channel frequency carrying the new service channel and to set the PID filter 230 with the updated PIDs.

In this exemplary embodiment, the mobile terminal compares the versions of the currently received PMT and previously stored PMT and, when the versions are not identical with each other, compares the PIDs listed in the currently received PMT and the PIDs listed in the previously stored PMT, before performing service channel switching. However, the present invention is not limited thereto. That is, the channel switching method of the present invention can be implemented with only one of the PMT version comparison step and the PIDs comparison step.

In the exemplary embodiment described above, the digital broadcast receiver is configured such that the demodulation controller 240 controls the tuner 200, demodulator 220, and PID filter 230. However, the present invention is not limited thereto. For example, the digital broadcast receiver of the present invention can also be configured such that the control unit 100 controls the tuner 200, demodulator 220, and PID filter 230.

Although exemplary embodiments of the present invention have been described hereinabove, it should be clearly understood that many variations and/or modifications of the basic inventive concepts herein taught which may appear to those skilled in the present art will still fall within the spirit and scope of the present invention, as defined in the appended claims and their equivalents.

As described above, the digital broadcast receiver and channel switching method of the present invention minimizes channel switching latency by skipping unnecessary PMT update and PIDs reset processes, resulting in fast channel switching.

What is claimed is:

1. A channel switching method for a digital broadcast receiver, the method comprising:
detecting a channel-switching command for switching to a service channel;
checking a first version of information of a currently received program mapping table received on the service channel upon detecting the channel-switching command;
comparing the first version of information with a second version of information of a previously received and stored program mapping table;
configuring the digital broadcast receiver with a set of packet identifiers (PIDs) associated with the service channel according to a result of the version information comparison; and
performing channel switching to the service channel using the set of PIDs.

2. The method of claim 1, wherein the configuring of the digital broadcast receiver comprises maintaining a set of PIDs listed in the previously received program mapping table when the first version of information and the second version of information are identical with each other.

3. The method of claim 1, wherein the configuring of the digital broadcast receiver comprises resetting the digital broadcast receiver with a new set of PIDs listed in the currently received program mapping table when the first version of information and the second version of information are different from each other.

4. The method of claim 1, wherein the configuring of the digital broadcast receiver comprises updating the set of PIDs with a new set of PIDs listed in the currently received program mapping table when the first version of information and the second version of information are different from each other.

5. The method of claim 1, wherein the configuring of the digital broadcast receiver comprises:
comparing, when the first version of information and the second version of information are different from each other, a set of PIDs listed in the currently received program mapping table with a set of PIDs listed in the previously received program mapping table; and
configuring the set of the PIDs of the digital broadcast receiver according to a result of the PID set comparison.

6. The method of claim 5, wherein the configuring of the set of the PIDs comprises maintaining, when the set of PIDs listed in the currently received program mapping table and the set of PIDs listed in the previously received program mapping table are identical with each other, the set of PIDs listed in the previously received program mapping table.

7. The method of claim 5, wherein the configuring of the set of the PIDs comprises updating, when the set of PIDs listed in the currently received program mapping table and the set of PIDs listed in the previously received program mapping table are different from each other, the set of the PIDs listed in the previously received program mapping table with the set of the PIDs listed in the currently received program mapping table.

8. The method of claim 5, wherein the configuring of the set of the PIDs comprises:
extracting, when the set of PIDs listed in the currently received program mapping table and the set of PIDs listed in the previously received program mapping table are different from each other, a first information from the set of PIDs listed in the currently received program mapping table; and
comparing the first information with a second information extracted from the set of PIDs listed in the previously received program mapping table.

9. The method of claim 8, wherein the configuring of the set of the PIDs further comprises updating, when the first information and the second information are different from each other, the set of PIDs listed in the previously received program mapping table with the set of PIDs listed in the currently received program mapping table.

10. The method of claim 8, wherein the configuring of the set of the PIDs further comprises maintaining, when the first information and the second information are identical with each other, the set of the PIDs listed in the previously received program mapping table.

11. A channel switching method for a digital broadcast receiver, the method comprising:
detecting a channel-switching command for switching to a service channel;
extracting a first information from a set of packet identifiers (PIDs) listed in a currently received program mapping table upon detecting the channel-switching command;
comparing the first information with a second information extracted from a set of PIDs listed in a previously received program mapping table;
configuring a set of PIDs of the digital broadcast receiver according to a result of the comparison between the first information and the second information; and
performing channel switching to the service channel using the set of PIDs of the digital broadcast receiver.

12. The method of claim 11, wherein the configuring of the set of PIDs comprises maintaining, when the first information and the second information are identical with each other, the set of PIDs listed in the previously received program mapping table.

13. The method of claim 11, wherein the configuring of the set of PIDs comprises updating, when the first information and the second information are different from each other, the set of PIDs listed in the previously received program mapping table with the set of PIDs listed in the currently received program mapping table.

14. The method of claim 11, further comprising creating a reference table containing the second information extracted from the PIDs listed in the previously received program mapping table.

15. A digital broadcast receiver, the receiver comprising:
an input unit for generating a channel switching command;
a tuner for receiving a broadcast signal on a service channel carried by a physical channel in response to the channel switching command;
a packet identifier (PID) filter for filtering packets having PIDs associated with the service channel, the PID filter being set with the PIDs; and
a demodulation controller for controlling update of the PIDs of the PID filter with reference to at least one of version of information of a program mapping table extracted from the broadcast signal and a set of PIDs listed in the program mapping table.

16. The receiver of claim 15, further comprising a memory unit for storing a set of PIDs of a previously received program mapping table.

17. The receiver of claim 15, wherein the demodulation controller compares a version of information of a currently received program mapping table with a version of information of a previously received program mapping table and maintains, when the version of information of the currently received program mapping table and the version of information of the previously received program mapping table are identical with each other, the set of the PIDs of the PID filter.

18. The receiver of claim 15, wherein the demodulation controller compares, when the version of information of a currently received program mapping table and the version of information of the previously received program mapping table are different from each other, a set of PIDs listed in the currently received program mapping table with a set of PIDs listed in the previously received program mapping table, and resets, when the set of PIDs listed in the currently received program mapping table and the set of PIDs listed in the previously received program mapping table are different from each other, the set of the PIDs of the PID filter with the set of the PIDs listed in the currently received program mapping table.

19. The receiver of claim 15, wherein the demodulation controller compares, when the version of information of a currently received program mapping table and the version of information of the previously received program mapping table are different from each other, a set of PIDs listed in the currently received program mapping table with a set of PIDs listed in the previously received program mapping table, and maintains, when the set of PIDs listed in the currently received program mapping table and the set of PIDs listed in the previously received program mapping table are identical with each other, the set of PIDs listed in the previously received program mapping table as the set of PIDs of the PID filter.
